(19) United States
(12) Patent Application Publication
(10) Pub. No.: US 2022/0034663 A1
(43) Pub. Date: Feb. 3, 2022

(54) MATCHING SUPPORT SYSTEM AND MATCHING SUPPORT METHOD

(71) Applicant: HONDA MOTOR CO., LTD., Tokyo (JP)

(72) Inventors: Daisuke Sawai, Tokyo (JP); Jun Kudo, Wako-shi (JP); Midori Kumakura, Tokyo (JP); Taichiro Sato, Wako-shi (JP)

(21) Appl. No.: 17/368,074

(22) Filed: Jul. 6, 2021

(30) Foreign Application Priority Data
Jul. 31, 2020 (JP) 2020-130560

(51) Int. Cl. G01C 21/34; G01C 21/36

(52) U.S. Cl. CPC G01C 21/343; G01C 21/3655; G01C 21/3617; G01C 21/3415

(57) ABSTRACT

A matching support system includes: a support request acceptance unit configured to accept a request for predetermined support from a user; a support provision acceptance unit configured to accept provision of the predetermined support by a supporter; a routine travel route recognition unit configured to recognize a routine travel route of the supporter; a supporter candidate extraction unit configured to extract, as a supporter candidate, the supporter having a distance from the routine travel route to a desired implementation location for the predetermined support equal to or less than a predetermined distance; and a matching proposal unit configured to transmit matching proposal information for proposing provision of the predetermined support for the user, to a supporter candidate terminal that is a supporter terminal used by the supporter candidate.

### INCORPORATION BY REFERENCE

The present application claims priority under 35 U.S.C. § 119 to Japanese Patent Application No. 2020-130560 filed on Jul. 31, 2020. The content of the application is incorporated herein by reference in its entirety.

### BACKGROUND OF THE INVENTION

### Field of the Invention

The present invention relates to a matching support system and a matching support method.

### Description of the Related Art

Conventionally, an information processing device has been proposed that, when accepting a support request including positional information from a person to be supported, acquires positional information of a plurality of supporters who provide support and determines one of the supporters who is asked for support for the person to be supported, based on the positional information of the person to be supported and the supporters (for example, see Japanese Patent Laid-Open No. 2020-21375). The information processing device transmits, to terminals of the person to be supported and the supporter, guide information for guiding them to meet each other; and guides the supporter to a waiting place of the person to be supported.

The aforementioned information processing device makes a request for support for a person to be supported, to a supporter who is in the vicinity of the person to be supported; and therefore, when there is no supporter in the vicinity of the person to be supported, the person to be supported cannot be matched with a supporter. In addition, when the guide information is inappropriate or insufficient, the person to be supported and a supporter cannot recognize each other and also in this case, the person to be supported cannot be matched with a supporter.

The present invention has been made in view of the background described above and it is an object of the present invention to provide a matching support system and a matching support method that can increase the rate of matching between a user desiring support and a supporter capable of providing the support.

### SUMMARY OF THE INVENTION

A first aspect to achieve the above object is a matching support system that supports matching between a user desiring predetermined support and a supporter capable of providing the predetermined support. The matching support system includes: a support request acceptance unit configured to receive support request information transmitted from a user terminal used by the user and to accept a request for the predetermined support from the user, the support request information including a desired implementation location, the desired implementation location being a location where the user desires to have the predetermined support implemented; a support provision acceptance unit configured to receive support provision information transmitted from a supporter terminal used by the supporter and to accept provision of the predetermined support by the supporter, the support provision information being for applying for provision of the predetermined support; a routine travel route recognition unit configured to recognize a routine travel route, the routine travel route being a routine travel route of the supporter; a supporter candidate extraction unit configured to extract the supporter as a supporter candidate to be matched with the user, the supporter having a distance from the routine travel route to the desired implementation location equal to or less than a predetermined distance; and a matching proposal unit configured to transmit matching proposal information to a supporter candidate terminal, the matching proposal information being for proposing provision of the predetermined support for the user, the supporter candidate terminal being the supporter terminal used by the supporter candidate.

The matching support system may further include a supporter attribute information acquisition unit configured to acquire supporter attribute information indicating an attribute of the supporter, wherein the routine travel route recognition unit may recognize the routine travel route based on the supporter attribute information.

The matching support system may further include: a supporter travel status recognition unit configured to recognize both the supporter candidate being traveling the routine travel route and a traveling direction of the supporter candidate on the routine travel route, based on positional information of the supporter candidate terminal, the positional information being transmitted from the supporter candidate terminal; and a desired implementation location information providing unit configured to cause the supporter candidate terminal to display a map showing the desired implementation location, the causing being performed when the supporter travel status recognition unit recognizes the supporter candidate being traveling the routine travel route in a predetermined direction and the desired implementation location is positioned in the traveling direction of the supporter candidate.

In the matching support system, the predetermined support may be for replacement of a battery and the matching proposal unit may transmit the matching proposal information including the minimum unit weight of the battery, to the supporter candidate terminal.

Here, the battery minimum unit weight refers to the weight of one battery to be replaced and as for a battery that can be divided into units for handling, it refers to the weight of the minimum unit obtained by division.

The matching support system may further include: a matching request acceptance unit configured to receive matching request information and to accept a request for matching with the user from the supporter candidate, the matching request information being for requesting the matching with the user, the matching request information being transmitted from the supporter candidate terminal in response to receipt of the matching proposal information; and a matching control unit configured to end acceptance of the request for the matching, the acceptance being performed by the matching request acceptance unit, the ending being performed when the matching proposal unit transmits the matching proposal information to a plurality of the supporter candidate terminals and then, the matching request acceptance unit accepts a first request for the matching.

Here, the request for matching with the user from the supporter candidate refers to the supporter candidate's action of offering to provide a predetermined service to the user.

The matching support system may further include: a matching request acceptance unit configured to receive matching request information and to accept a request for matching with the user from the supporter candidate, the matching request information being for requesting the matching with the user, the matching request information being transmitted from the supporter candidate terminal in response to receipt of the matching proposal information; and a matching control unit configured to perform matching with the user when the matching proposal unit transmits the matching proposal information to a plurality of the supporter candidate terminals and the matching request acceptance unit accepts requests for the matching from a plurality of the supporter candidates, the matching being performed so as to cause one of the supporter candidates, the one having a higher likelihood of passing the routine travel route, to be preferentially matched with the user, rather than others of the supporter candidates, the others having a lower likelihood of passing the routine travel route.

Here, the likelihood of passing the routine travel route refers to the possibility or probability of the supporter passing the routine travel route.

The matching support system may further include a support continuation registration unit configured to perform support continuation registration for the user and the supporter candidate when receiving either support request continuation information transmitted from the user terminal or support provision continuation information transmitted from the supporter candidate terminal after the supporter candidate performs the predetermined support for the user, the support request continuation information indicating an intention to request the predetermined support for the next time to the supporter candidate, the support provision continuation information indicating an intention to provide the predetermined support for the next time to the user, wherein the matching proposal unit may transmit the matching proposal information to the supporter candidate terminal of the supporter candidate with the support continuation registration preferentially rather than the supporter candidate without the support continuation registration.

A second aspect to achieve the above object is a matching support method that is executed by a computer so as to support matching between a user desiring predetermined support and a supporter capable of providing the predetermined support. The matching support method includes: a support request accepting step of receiving support request information transmitted from a user terminal used by the user and accepting a request for the predetermined support from the user, the support request information including a desired implementation location, the desired implementation location being a location where the user desires to have the predetermined support implemented; a support provision accepting step of receiving support provision information transmitted from a supporter terminal used by the supporter and accepting provision of the predetermined support by the supporter, the support provision information being for applying for provision of the predetermined support; a routine travel route recognition step of recognizing a routine travel route, the routine travel route being a routine travel route of the supporter; a supporter candidate extraction step of extracting the supporter as a supporter candidate to be matched with the user, the supporter having a distance from the routine travel route to the desired implementation location equal to or less than a predetermined distance; and a matching proposing step of transmitting matching proposal information to a supporter candidate terminal, the matching proposal information being for proposing provision of the predetermined support for the user, the supporter candidate terminal being the supporter terminal used by the supporter candidate.

### Advantageous Effects of Invention

The matching support method allows the rate of matching between a user and a supporter to be improved by extracting a supporter candidate who routinely passes near the implementation location of a predetermined support desired by the user.

### BRIEF DESCRIPTION OF THE DRAWINGS

FIG. 1 is an illustration of an aspect of supporting matching between a user and a supporter for support for battery replacement by a user at home;

FIG. 2 is a configuration diagram of a matching support system;

FIG. 3 is an illustration of supporter information recorded in a supporter DB;

FIG. 4 is a first flowchart for matching support processing for a user and a supporter;

FIG. 5 is a second flowchart for the matching support processing for the user and the supporter; and

FIG. 6 is an illustration of an aspect of supporting matching between a user and a supporter for support for battery replacement at a battery station.

### DETAILED DESCRIPTION OF THE PREFERRED EMBODIMENTS

### 1. Overview of Matching Support Service

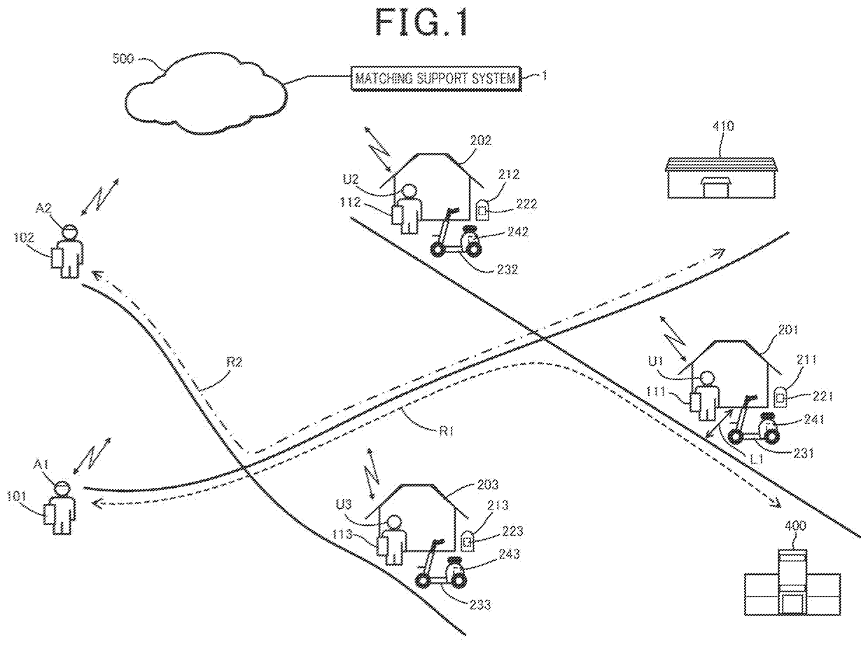

The overview of a matching support service performed by a matching support system 1 of an embodiment will be described with reference to FIG. 1. The matching support system 1 supports matching between users U1 to U3 who request support for portable battery replacement (which corresponds to a predetermined support of the present invention) and supporters A1 and A2 who provide the support.

FIG. 1 illustrates an aspect of matching for supporting the replacement of batteries 241 to 243 of electric motorcycles 231 to 233. A user U1 requests support for replacing the battery 241 of the electric motorcycle 231 at a home 201. A charger 211 is installed in the home 201; and the battery 241 which is housed in the electric motorcycle 231 and has an insufficient remaining power storage amount is replaced with a battery 221 which has been charged by the charger 211. The battery 241 which has been removed from the electric motorcycle 231 is set on the charger 211 to be charged.

Similarly, a charger 212 is installed in a home 202 of the user U2; and the battery 242 housed in the electric motorcycle 232 is replaced with a battery 222 which has been charged by the charger 212. In addition, a charger 213 is installed in a home 203 of the user U3; and the battery 243 housed in the electric motorcycle 233 is replaced with a battery 223 which has been charged by the charger 213.

The users U1 to U3 respectively start matching applications (application programs) for support which have been installed in their user terminals 111 to 113 and perform an operation for requesting support for replacing the batteries 241 to 243. In response to the operation for this request, support request information for requesting support for battery replacement is transmitted from the user terminals 111 to 113 to the matching support system 1.

The matching support system 1 receives the support request information and accepts the support requests. The support request information includes desired implementation locations where the users U1 to U3 desire to have the support implemented. In an example of FIG. 1, locations where the homes 201 to 203 of the users U1 to U3 are placed are their desired implementation locations.

The supporters A1 and A2 who can provide the support start the support matching applications which are installed in their supporter terminals 101 and 102, respectively and perform an operation for applying for provision of the support for battery replacement. The supporters A1 and A2 perform the operation for applying for provision of the support for battery replacement when desiring to support battery replacement or when having an intention to support battery replacement. In response to this operation, support provision information is transmitted from the supporter terminals 101 and 102 to the matching support system 1. The matching support system 1 receives the support provision information and accepts provision of the support.

The user terminals 111 to 113 and the supporter terminals 101 and 102 are smartphones, mobile phones, or portable communication terminals such as tablet terminals; and each composed of a terminal processor, a memory, a communication circuit, an input/output circuit, a global positioning system (GPS) sensor, and the like which are not illustrated. The terminal processor first reads the matching application described above from the memory and then executes it. The matching application may be downloaded from an external system such as the matching support system 1 to the user terminals 111 to 113 and the supporter terminals 101 and 102; or may be read from a recording medium (an optical disk, a magnetic disk, a flash memory, or the like) to the user terminals 111 to 113 and the supporter terminals 101 and 102.

The matching support system 1 recognizes routine travel routes that are routes that the supporters A1 and A2 routinely travel, based on travel histories and attributes of the supporters A1 and A2. The travel histories of the supporters A1 and A2 are obtained based on the positions of the supporter terminals 101 and 102 which are detected by GPS sensors included in the supporter terminals 101 and 102. The attributes of each of the supporters are supporter's age, occupation/student, home location, work/school location, and the like.

The matching support system 1 recognizes a location through which each of the supporters A1 and A2 frequently passes and a time of day when each of them passes through the location, from the travel histories of the supporters A1 and A2, thereby recognizing their routine travel routes. In addition, in a case where the location of a home of each of the supporters A1 and A2, the location of a school or a company to which each of them commutes, or the like, or the school, company or the like to which each of the supporters A1 and A2 belongs is registered as each of the attributes of the supporters A1 and A2, when travel between any two of the locations and the like is performed, the matching support system 1 recognizes a travel route between these locations as each of their routine travel routes. When the attributes of the supporters A1 and A2 are not registered, the matching support system 1 estimates their routine travel routes from a location through which each of the supporters A1 and A2 passes and a time of day when each of them passes through the location. The matching support system 1 determines the supporter A1 as a student commuting to a university 400 when recognizing, from the travel history of the supporter A1, that the supporter A1 has continued to stay in the premises of the university 400 for a long time, for example.

In the example of FIG. 1, a university student and the location of the university 400 to which the student commutes are registered in the matching support system 1 as attributes of the supporter A1. In addition, an office worker and the location of a company 410 to which the office worker commutes are registered in the matching support system 1 as attributes of the supporter A2. The matching support system 1 recognizes R1 that is a commuting route to the university 400 of the supporter A1 as a routine travel route of the supporter A1. In addition, since an attribute of the supporter A2 is an office worker, the matching support system 1 recognizes R2 that is a commuting route to the company 410 of the supporter A2 as a routine travel route of the supporter A2.

The matching support system 1 proposes matching by extracting a combination of a user and a supporter that makes a distance from a routine travel route to a desired implementation location (the shortest distance) equal to or less than a predetermined distance, from among the users U1 to U3 whose support requests have been accepted and the supporters A1 and A2 whose support provision has been accepted.

In the example of FIG. 1, the matching support system 1 proposes matching between the user U1 and the supporter A1 since a distance L1 from the home 201 that is a desired implementation location of the user U1 to the routine travel route R1 is equal to or less than the predetermined distance. More specifically, the matching support system 1 transmits matching proposal information for proposing support for the user U1, to the supporter terminal 101 of the supporter A1.

When receiving, from the supporter terminal 101, matching request information for requesting matching with the user U1, the matching support system 1 establishes matching between the user U1 and the supporter A1 and transmits matching establishment information to the user terminal 111 and the supporter terminal 101.

The supporter A1 visits the home 201 of the user U1 on the way to the university 400 and performs battery replacement of the electric motorcycle 231. More specifically, the supporter A1 removes the battery 241 whose remaining power storage amount has become insufficient from the electric motorcycle 231 and replaces it with the battery 221 which has been charged by the charger 211. After that, the supporter A1 sets the battery 241 which has been removed on the charger 211 to start charging.

As described above, matching with the user U1 is proposed to the supporter A1 who can easily visit the home 201 of the user U1, thereby allowing an improvement in a matching rate. In addition, when a user U1 is an elderly person or a woman and has difficulty in replacing a relatively heavy battery, replacement of the battery can be supported by the supporter A1.

### 2. Configuration of Matching Support System

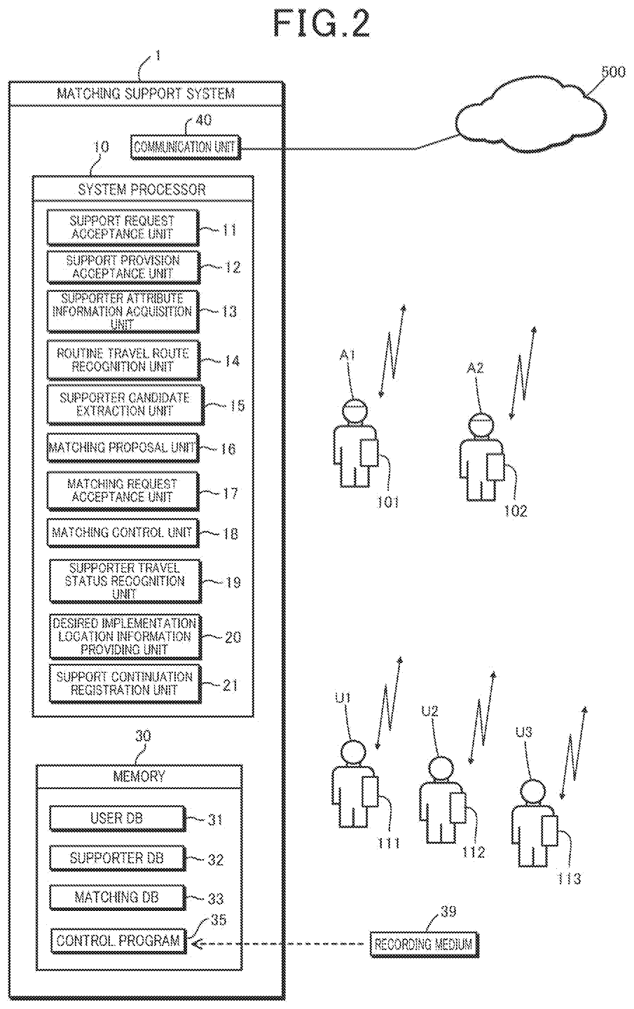

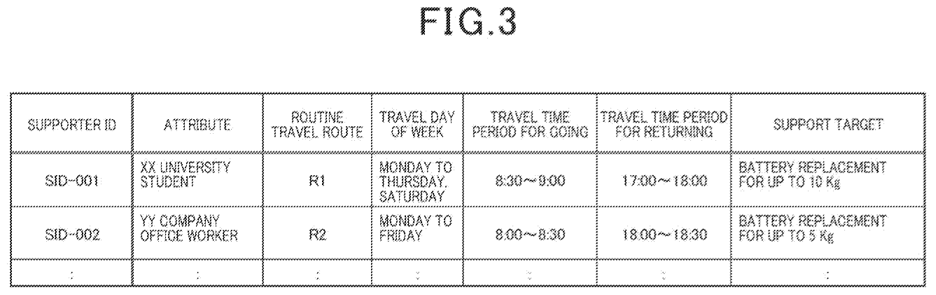

A configuration of the matching support system 1 will be described with reference to FIG. 2 and FIG. 3. As shown in FIG. 2, the matching support system 1 is a computer system including a system processor 10, a memory 30, a communication unit 40, and the like; and performs communication, by using the communication unit 40, between the supporter terminals 101 and 102 and the user terminals 111 to 113 via a communication network 500.

The memory 30 stores a user data base (DB) 31, a supporter DB 32, a matching DB 33, and a control program 35 for the matching support system 1. In the user DB 31, information on a user whose support request has been accepted is recorded. In the supporter DB 32, information on a supporter whose support provision has been accepted is recorded. In the matching DB 33, information on a user and a supporter between which matching has been established is recorded. The control program 35 may be downloaded from a server, which is not illustrated, to the matching support system 1 or may be read from a recording medium 39 (an optical disk, magnetic disk, flash memory, or the like).

The system processor 10 is composed of one or a plurality of processors. The system processor 10 functions, by reading and executing the control program 35, as a support request acceptance unit 11, a support provision acceptance unit 12, a supporter attribute information acquisition unit 13, a routine travel route recognition unit 14, a supporter candidate extraction unit 15, a matching proposal unit 16, a matching request acceptance unit 17, a matching control unit 18, a supporter travel status recognition unit 19, a desired implementation location information providing unit 20, and a support continuation registration unit 21.

Processing executed by the support request acceptance unit 11 corresponds to a support request accepting step in a matching support method of the present invention and processing executed by the support provision acceptance unit 12 corresponds to a support provision accepting step in the matching support method of the present invention. Processing executed by the routine travel route recognition unit 14 corresponds to a routine travel route recognition step in the matching support method of the present invention and processing executed by the supporter candidate extraction unit 15 corresponds to a supporter candidate extraction step in the matching support method of the present invention. Processing executed by the matching proposal unit 16 corresponds to a matching proposing step in the matching support system of the present invention.

The support request acceptance unit 11 receives support request information transmitted from the user terminals 111 to 113 and accepts support requests from the users U1 to U3. The support request information includes a desired implementation location that is a location desired by each of the users U1 to U3 for support, details of the support, and the like. In the present embodiment, the desired implementation locations are the homes 201 to 203 of the users U1 to U3 and the details of the support include replacement of the batteries of the electric motorcycles 231 to 233, as described above. The support request acceptance unit 11 records the support request information in the user DB 31.

The support provision acceptance unit 12 receives support provision information transmitted from the supporter terminals 101 and 102 and accepts application for support provision from the supporters A1 and A2. The support provision information includes the attributes of the supporters A1 and A2, past travel history information, details of support that can be provided, and the like. The support provision acceptance unit 12 issues a supporter ID to each of the supporters as shown in FIG. 3 and records information on each of the supporters, in the supporter DB 32.

The travel history information of the supporters A1 and A2 are collected by the respective matching applications based on the positions of the supporter terminals 101 and 102, which are detected by the respective GPS sensors of the supporter terminals 101 and 102, and the date and time of detecting the position. Alternatively, the supporters A1 and A2 may input their own travel histories into the supporter terminals 101 and 102 by the matching applications. Further alternatively, the travel history information of the supporters A1 and A2 may be acquired based on action histories of the supporters A1 and A2 which are recorded in the respective schedule applications installed in the supporter terminals 101 and 102.

FIG. 3 shows an example in which a supporter ID “SID-001” is issued to the supporter A1 and a supporter ID “SID-002” is issued to the supporter A2, and an attribute, a routine travel route, travel days of a week, a travel time period for going, a travel time period for returning, and a support target are recorded.

The supporter attribute information acquisition unit 13 extracts the attributes of the supporters A1 and A2 from the support provision information and records them in the supporter DB 32. The routine travel route recognition unit 14 recognizes the routine travel routes of the supporters A1 and A2 based on the travel history information and attributes of the supporters A1 and A2, and records them in the supporter DB 32. In the example of FIG. 1, the R1 is recognized as the routine travel route of the supporter A1, and the R2 is recognized as the routine travel route of the supporter A2.

Alternatively, the routine travel routes of the supporters A1 and A2 may be recognized based on future action plans of the supporters A1 and A2 which are recorded in the respective schedule applications installed in the supporter terminals 101 and 102.

The supporter candidate extraction unit 15 searches for a combination of a supporter having a distance from a routine travel route to a desired implementation location equal to or less than a predetermined distance and a user by referring to both information on the users U1 to U3 which is recorded in the user DB 31 and information on the supporters A1 and A2; and extracts a supporter with which the combination is established, as a supporter candidate to which matching is proposed.

The matching proposal unit 16 transmits, to a supporter terminal (supporter candidate terminal) used by the supporter candidate, matching proposal information for proposing provision of support for battery replacement for a user with which the combination is established (hereafter, referred to as a combined user). The matching proposal information includes the minimum unit weight of a battery whose replacement is desired by the combined user; and the supporter candidate can determine whether to accept the proposal of matching by recognizing the minimum unit weight of the battery to be replaced.

The matching request acceptance unit 17 receives matching request information for requesting matching with the combined user, which is transmitted from the supporter candidate terminal, and accepts a matching request from the supporter candidate. The request for matching from the supporter candidate refers to the supporter candidate's action of offering to provide a battery replacement service to the combined user. The matching control unit 18 executes processing to deal with a situation where a plurality of supporter candidates are extracted by the supporter candidate extraction unit 15 and matching proposal information is transmitted to supporter candidate terminals of the plurality of supporter candidates by the matching proposal unit 16.

More specifically, the matching control unit 18 ends the acceptance for matching by the matching request acceptance unit 17 when receiving matching request information from any one of the plurality of supporter candidates for the first time. Then, the matching control unit 18 determines as a supporter to be matched with the combined user, the supporter candidate who has transmitted the matching request information first. Alternatively, when the matching request acceptance unit 17 accepts matching requests from a plurality of supporter candidates, the matching control unit 18 may determine a supporter candidate who has the highest likelihood of passing a routine travel route as a supporter to be matched with the combined user.

The likelihood of a supporter candidate's passing his/her routine travel route is calculated, for example, from the ratio of the number of specific timings (in the mornings and evenings of Monday to Friday, for example) at which the supporter candidate has actually passed the routine travel route with respect to a predetermined number of the specified timings in the past, based on the travel history of the supporter candidate. In this case, the more the number of times the supporter candidate actually has passed the routine travel route is, the higher the likelihood of the supporter candidate's passing the routine travel route becomes.

The supporter travel status recognition unit 19 recognizes both the supporter candidate being traveling the routine travel route and a traveling direction of the supporter candidate on the routine travel route, based on the positional information of the supporter terminal which is transmitted from the supporter terminal (supporter candidate terminal) carried by the supporter candidate.

The desired implementation location information providing unit 20 transmits, when the supporter travel status recognition unit 19 recognizes both the supporter candidate being traveling the routine travel route and the traveling direction of the supporter candidate on the routine travel route, display control information instructing to display a map showing the desired implementation location of the combined user to the supporter candidate terminal. This allows the supporter candidate who is traveling the routine travel route in the direction of the desired implementation location to easily recognize the desired implementation location.

When support for the user U1 by the supporter A1 who are matched with each other by the matching control unit 18 has been performed, the support continuation registration unit 21 performs support continuation registration for the user U1 and the supporter A1 at the time of receiving either support request continuation information indicating an intention to request the support for the next time to the supporter A1, which is transmitted from the user terminal 111, or support provision continuation information indicating an intention to provide support to the user U1, which is transmitted from the supporter terminal 101. The support continuation registration unit 21 records information on the support continuation registration in the matching DB 33.

The matching proposal unit 16 matches the combined user with a supporter candidate for which the support continuation registration has been performed preferentially rather than a supporter candidate for which support continuation registration has not been performed. More specifically, the matching proposal unit 16 selects a supporter candidate for which support continuation registration has been performed, preferentially rather than a supporter candidate for which support continuation registration has not been performed; and transmits matching proposal information to a supporter terminal of the selected supporter candidate.

### 3. Matching Processing Between User and Supporter

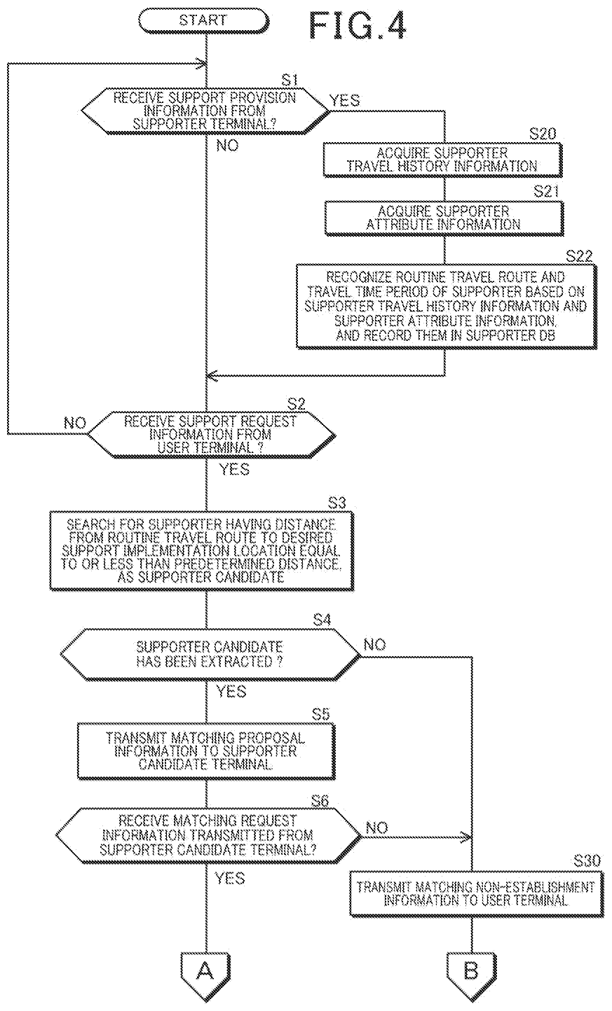

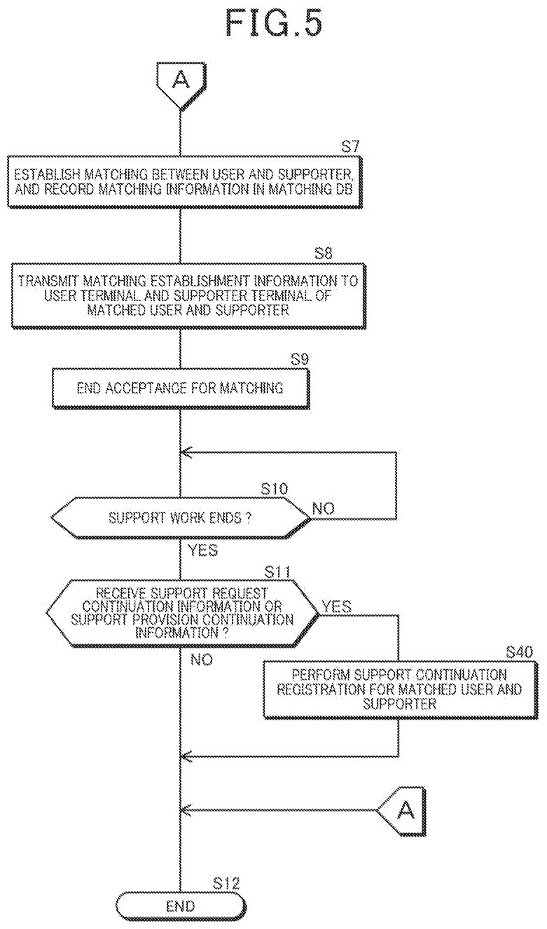

A series of matching processing procedures between users U1 to U3 and supporters A1 and A2, which is executed by the matching support system 1 in a situation shown in FIG. 1, will be described with reference to flowcharts shown in FIG. 4 and FIG. 5.

At step S1 of FIG. 4, if the support provision acceptance unit 12 receives support provision information from the supporter terminals 101 and 102, it accepts provision of support by the supporters A1 and A2 and advances the processing to step S20. At step S20, the routine travel route recognition unit 14 acquires supporter travel history information from the support provision information. At the subsequent step S21, the supporter attribute information acquisition unit 13 recognizes the attributes of the supporters A1 and A2 from the support provision information.

At the next step S22, the routine travel route recognition unit 14 recognizes the routine travel routes R1 and R2 and travel time periods of the supporters A1 and A2 based on supporter travel route information and supporter attribute information, records them in the supporter DB 32, and advances the processing to step S2.

On the other hand, if the support provision acceptance unit 12 does not receive support provision information from the supporter terminals 101 and 102, it advances the processing to step S2. At step S2, if the support request acceptance unit 11 receives support request information from the user terminals 111 to 113, it accepts support requests by the users U1 to U3 and advances the processing to step S3. If the support request acceptance unit 11 does not receive the support request information, it advances the processing to step S1.

At step S3, the supporter candidate extraction unit 15 searches for a combination of a supporter having a distance from a routine travel route to a desired implementation location equal to or less than a predetermined distance and a user by referring to the user DB 31 and the supporter DB 32; extracts the supporter with which the combination has been established, as a supporter candidate to which matching is proposed; and advances the processing to step S4. On the other hand, if a supporter candidate is not extracted, the supporter candidate extraction unit 15 advances the processing to step S30 and transmits matching non-establishment information indicating that there is no possible supporter for matching found, to the user terminal. Then, the supporter candidate extraction unit 15 advances the processing to step S40 of FIG. 5 and ends the series of processing procedures.

In the example of FIG. 1, the supporter candidate extraction unit 15 extracts the supporter A1 as a supporter candidate in a combination of the user U1 and the supporter A1. At step S5, the matching proposal unit 16 transmits matching proposal information for proposing provision of support for the user U1, to the supporter terminal 101 (supporter candidate terminal) of the supporter A1. At the subsequent step S6, if the matching control unit 18 receives matching request information transmitted from the supporter terminal 101, it advances the processing to step S7 of FIG. 5 and if not receiving the matching request information, it advances the processing to step S30.

At step S7, the matching control unit 18 establishes matching between the user U1 and the supporter A1, and records matching information in the matching DB 33. At the subsequent step S8, the matching control unit 18 transmits matching establishment information indicating that matching has been established, to the user terminal 111 and supporter terminal 101 of the user U1 and supporter A1, respectively which have been matched with each other.

At the next step S9, the matching control unit 18 ends acceptance for matching by the matching request acceptance unit 17. This can prevent a conflict from occurring due to accepting matching applications from a plurality of supporter candidates. In addition, display control information for instructing a display unit of the supporter terminal 101 to display a map showing a desired implementation location of the user U1 is transmitted to the supporter terminal 101 by processing of the supporter travel status recognition unit 19 and the desired implementation location information providing unit 20. This allows the supporter A1 to easily recognize the desired implementation location of the user U1 by visually checking the map displayed on the display unit of the supporter terminal 101.

At step S10, if the support continuation registration unit 21 receives support end information indicating that support for the user U1 by the supporter A1 has ended from the user terminal 111 or the supporter terminal 101, it recognizes the end of the support and advances the processing to step S11. At step S11, if the support continuation registration unit 21 receives support request continuation information indicating an intention to request a service by the supporter A1 for the next time, which is transmitted from the user terminal 111, or if it receives support provision continuation information indicating an intention to provide support for the next time to the user U1, which is transmitted from the supporter terminal 101, it advances the processing to step S40.

At step S40, support continuation information for the user U1 and the supporter A1 which have been matched with each other is recorded in the matching DB 33 to perform support continuation registration for the user U1 and the supporter A1, and the processing is advanced to step S12, which ends the series of processing procedures. Based on the support continuation registration, when the user U1 requests support for the next time, the supporter candidate extraction unit 15 extracts the supporter A1 preferentially as a supporter candidate. On the other hand, if the support continuation registration unit 21 does not receive either the support request continuation information or support provision continuation information, it advances the processing to step S12 to end the series of processing procedures.

### 4. Other Embodiments

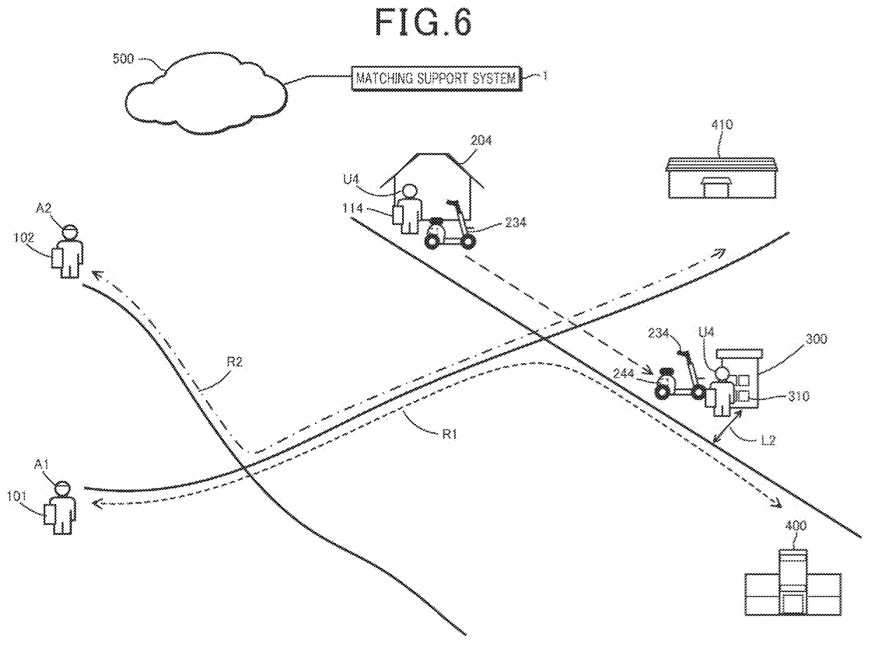

FIG. 1 illustrates an embodiment where the users U1 to U3 request support for battery replacement by setting the homes 201 to 203 of the users U1 to U3, respectively, as their desired implementation locations for the support. In another embodiment, also when a user U4 sets a battery station 300 installed near his/her home 204 as a desired implementation location for support for battery replacement as shown in FIG. 6, matching between the user and a supporter by the matching support system 1 is possible in a similar manner.

In an example of FIG. 6, components similar to those in FIG. 1 are denoted by the same reference signs and descriptions thereof will be omitted. The matching support system 1 extracts, as a supporter candidate to be matched with the user U4, the supporter A1 having a distance L2 from his/her routine travel route R1 to the battery station 300 equal to or less than a predetermined distance, out of the supporters A1 and A2. Then, it executes processing for matching between the user U4 and the supporter A1 in a similar manner as the example of FIG. 1.

The user U4 travels to the battery station 300 by an electric motorcycle 234 and waits there on a date and time notified by matching establishment information. The supporter A1 visits the battery station 300 on the way to passing the routine travel route R1 on the date and time notified by the matching establishment information. Then, the supporter A1 removes a battery 244 of the electric motorcycle 234 that has been waiting and replaces it with a battery 310 which has been charged by the battery station 300, and sets the battery 244 on the battery station 300.

In the embodiment, the supporter attribute information acquisition unit 13 is provided and the routine travel route recognition unit 14 recognizes a routine travel route of a supporter based on the travel history information and attributes of the supporter. In another embodiment, the supporter attribute information acquisition unit 13 may be omitted and the routine travel route may be recognized only based on travel history information.

In the embodiment, the supporter travel status recognition unit 19 and the desired implementation location information providing unit 20 are provided and processing for causing a supporter candidate terminal to display a map showing a desired implementation location is performed; however, the supporter travel status recognition unit 19 and the desired implementation location information providing unit 20 may be omitted.

In the embodiment, the support continuation registration unit 21 is provided and processing for promoting a continuous support relationship between a user and a supporter between which matching has been established is performed; however, the support continuation registration unit 21 may be omitted.

In the embodiment, support for battery replacement is presented as a predetermined support of the present invention; however, the predetermined support is not limited thereto and the present invention can be applied to various kinds of support performed in a situation where there are a user requesting support and a supporter capable of providing the support.

Although FIG. 2 is a schematic diagram illustrating the matching support system 1 in a manner in which the functional configurations are classified according to the main processing contents thereof for easy understanding of the present invention, the configuration of the matching support system 1 may be obtained in a different classification manner. In addition, processing of each component may be executed by one hardware unit or may be executed by a plurality of hardware units. Furthermore, processing of each component shown in FIG. 4 and FIG. 5 may be executed by one program or may be executed by a plurality of programs.

### 5. Configuration Supported by the Embodiment

The embodiment is a specific example of the following configurations.

(1) A matching support system that supports matching between a user desiring predetermined support and a supporter capable of providing the predetermined support, comprising: a support request acceptance unit configured to receive support request information transmitted from a user terminal used by the user and to accept a request for the predetermined support from the user, the support request information including a desired implementation location, the desired implementation location being a location where the user desires to have the predetermined support implemented; a support provision acceptance unit configured to receive support provision information transmitted from a supporter terminal used by the supporter and to accept provision of the predetermined support by the supporter, the support provision information being for applying for provision of the predetermined support; a routine travel route recognition unit configured to recognize a routine travel route, the routine travel route being a routine travel route of the supporter; a supporter candidate extraction unit configured to extract the supporter as a supporter candidate to be matched with the user, the supporter having a distance from the routine travel route to the desired implementation location equal to or less than a predetermined distance; and a matching proposal unit configured to transmit matching proposal information to a supporter candidate terminal, the matching proposal information being for proposing provision of the predetermined support for the user, the supporter candidate terminal being the supporter terminal used by the supporter candidate.

According to the matching support system of item 1, the supporter candidate who routinely passes near a location where the user desires to have a predetermined support implemented is extracted, thereby allowing an improvement in the rate of matching between the user and the supporter.

(2) The matching support system according to item 1, further comprising a supporter attribute information acquisition unit configured to acquire supporter attribute information indicating an attribute of the supporter, wherein the routine travel route recognition unit recognizes the routine travel route based on the supporter attribute information.

According to the matching support system of item 2, the accuracy of determining the routineness of a route that the supporter travels can be improved by using the supporter attribute information.

(3) The matching support system according to item 1 or 2, further comprising: a supporter travel status recognition unit configured to recognize both the supporter candidate being traveling the routine travel route and a traveling direction of the supporter candidate on the routine travel route, based on positional information of the supporter candidate terminal, the positional information being transmitted from the supporter candidate terminal; and a desired implementation location information providing unit configured to cause the supporter candidate terminal to display a map showing the desired implementation location, the causing being performed when the supporter travel status recognition unit recognizes the supporter candidate being traveling the routine travel route in a predetermined direction and the desired implementation location is positioned in the traveling direction of the supporter candidate.

According to the matching support system of item 3, the supporter candidate can easily recognize the desired implementation location.

(4) The matching support system according to any one of items 1 to 3, wherein the predetermined support is for replacement of a battery and the matching proposal unit transmits the matching proposal information including a minimum unit weight of the battery to the supporter candidate terminal.

According to the matching support system of item 4, the supporter candidate can determine whether he/she can support battery replacement by recognizing the weight of a battery to be handled.

(5) The matching support system according to any one of items 1 to 4, further comprising: a matching request acceptance unit configured to receive matching request information and to accept a request for matching with the user from the supporter candidate, the matching request information being for requesting the matching with the user, the matching request information being transmitted from the supporter candidate terminal in response to receipt of the matching proposal information; and a matching control unit configured to end acceptance of the request for the matching, the acceptance being performed by the matching request acceptance unit, the ending being performed when the matching proposal unit transmits the matching proposal information to a plurality of the supporter candidate terminals and then, the matching request acceptance unit accepts a first request for the matching.

According to the matching support system of item 5, a conflict between requests for matching from a plurality of supporter candidates is prevented from occurring, thereby allowing matching between a user and a supporter candidate to be easily performed.

(6) The matching support system according to any one of items 1 to 4 further comprising: a matching request acceptance unit configured to receive matching request information and to accept a request for matching with the user from the supporter candidate, the matching request information being for requesting the matching with the user, the matching request information being transmitted from the supporter candidate terminal in response to receipt of the matching proposal information; and a matching control unit configured to perform matching with the user when the matching proposal unit transmits the matching proposal information to a plurality of the supporter candidate terminals and the matching request acceptance unit accepts requests for the matching from a plurality of the supporter candidates, the matching being performed so as to cause one of the supporter candidates, the one having a higher likelihood of passing the routine travel route, to be preferentially matched with the user, rather than others of the supporter candidates, the others having a lower likelihood of passing the routine travel route.

According to the matching support system of item 6, a supporter candidate having a higher frequency of passing a routine travel route and having a higher likelihood of passing near a location where a user desires to have a predetermined support provided is matched with the user, thereby allowing an improvement in the rate of matching between the user and the supporter candidate.

(7) The matching support system according to any one of items 1 to 6, further comprising a support continuation registration unit configured to perform support continuation registration for the user and the supporter candidate when receiving either support request continuation information transmitted from the user terminal or support provision continuation information transmitted from the supporter candidate terminal after the supporter candidate performs the predetermined support for the user, the support request continuation information indicating an intention to request the predetermined support for a next time to the supporter candidate, the support provision continuation information indicating an intention to provide the predetermined support for a next time to the user, wherein the matching proposal unit transmits the matching proposal information to the supporter candidate terminal of the supporter candidate with the support continuation registration preferentially rather than the supporter candidate without the support continuation registration.

According to the matching support system of item 7, support continuation registration for the user and the supporter is performed after implementation of the predetermined support, according to an intention of either the supporter candidate having provided the predetermined support or the user having received the predetermined support. In addition, transmission of the matching proposal information by the matching proposal unit is performed preferentially for the supporter candidate for which matching registration has been performed; and thereby, the predetermined support is continuously implemented for the same user and by the same supporter and thus, a good relationship between the supporter and the user can be expected to be built.

(8) A matching support method that is executed by a computer so as to support matching between a user desiring predetermined support and a supporter capable of providing the predetermined support, comprising: a support request accepting step of receiving support request information transmitted from a user terminal used by the user and accepting a request for the predetermined support from the user, the support request information including a desired implementation location, the desired implementation location being a location where the user desires to have the predetermined support implemented; a support provision accepting step of receiving support provision information transmitted from a supporter terminal used by the supporter and accepting provision of the predetermined support by the supporter, the support provision information being for applying for provision of the predetermined support; a routine travel route recognition step of acquiring supporter travel history information on a past travel route of the supporter and recognizing a routine travel route based on the supporter travel history information, the routine travel route being a routine travel route of the supporter; a supporter candidate extraction step of extracting the supporter as a supporter candidate to be matched with the user, the supporter having a distance from the routine travel route to the desired implementation location equal to or less than a predetermined distance; and a matching proposing step of transmitting matching proposal information to a supporter candidate terminal, the matching proposal information being for proposing provision of the predetermined support for the user, the supporter candidate terminal being the supporter terminal used by the supporter candidate.

By executing the matching support method of item 8 by a computer, the same action and effect as those in the matching support system of item 1 can be obtained.

### REFERENCE SIGNS LIST

1 matching support system
10 system processor
11 support request acceptance unit
12 support provision acceptance unit
13 supporter attribute information acquisition unit
14 routine travel route recognition unit
15 supporter candidate extraction unit
16 matching proposal unit
17 matching request acceptance unit
18 matching control unit
19 supporter travel status recognition unit
20 desired implementation location information providing unit
21 support continuation registration unit
30 memory
31 user DB
32 supporter DB
33 matching DB
35 control program
101, 102 supporter terminal
111, 112, 113, 114 user terminal
A1, A2 supporter
U1, U2, U3, U4 user
R1, R2 routine travel route

What is claimed is:

1. A matching support system that supports matching between a user desiring predetermined support and a supporter capable of providing the predetermined support, comprising:
a support request acceptance unit configured to receive support request information transmitted from a user terminal used by the user and to accept a request for the predetermined support from the user, the support request information including a desired implementation location, the desired implementation location being a location where the user desires to have the predetermined support implemented;
a support provision acceptance unit configured to receive support provision information transmitted from a supporter terminal used by the supporter and to accept provision of the predetermined support by the supporter, the support provision information being for applying for provision of the predetermined support;
a routine travel route recognition unit configured to recognize a routine travel route, the routine travel route being a routine travel route of the supporter;
a supporter candidate extraction unit configured to extract the supporter as a supporter candidate to be matched with the user, the supporter having a distance from the routine travel route to the desired implementation location equal to or less than a predetermined distance; and
a matching proposal unit configured to transmit matching proposal information to a supporter candidate terminal, the matching proposal information being for proposing provision of the predetermined support for the user, the supporter candidate terminal being the supporter terminal used by the supporter candidate.

2. The matching support system according to claim 1, further comprising:
a supporter attribute information acquisition unit configured to acquire supporter attribute information indicating an attribute of the supporter, wherein
the routine travel route recognition unit recognizes the routine travel route based on the supporter attribute information.

3. The matching support system according to claim 1, further comprising:
a supporter travel status recognition unit configured to recognize both the supporter candidate being traveling the routine travel route and a traveling direction of the supporter candidate on the routine travel route, based on positional information of the supporter candidate terminal, the positional information being transmitted from the supporter candidate terminal; and
a desired implementation location information providing unit configured to cause the supporter candidate terminal to display a map showing the desired implementation location, the causing being performed when the supporter travel status recognition unit recognizes the supporter candidate being traveling the routine travel route in a predetermined direction and the desired implementation location is positioned in the traveling direction of the supporter candidate.

4. The matching support system according to claim 1, wherein
the predetermined support is for replacement of a battery; and
the matching proposal unit transmits the matching proposal information including a minimum unit weight of the battery, to the supporter candidate terminal.

5. The matching support system according to claim 1, further comprising:
a matching request acceptance unit configured to receive matching request information and to accept a request for matching with the user from the supporter candidate, the matching request information being for requesting the matching with the user, the matching request information being transmitted from the supporter candidate terminal in response to receipt of the matching proposal information; and
a matching control unit configured to end acceptance of the request for the matching, the acceptance being performed by the matching request acceptance unit, the ending being performed when the matching proposal unit transmits the matching proposal information to a plurality of the supporter candidate terminals and then, the matching request acceptance unit accepts a first request for the matching.

6. The matching support system according to claim 1, further comprising:
a matching request acceptance unit configured to receive matching request information and to accept a request for matching with the user from the supporter candidate, the matching request information being for requesting the matching with the user, the matching request information being transmitted from the supporter candidate terminal in response to receipt of the matching proposal information; and
a matching control unit configured to perform matching with the user when the matching proposal unit transmits the matching proposal information to a plurality of the supporter candidate terminals and the matching request acceptance unit accepts requests for the matching from a plurality of the supporter candidates, the matching being performed so as to cause one of the supporter candidates, the one having a higher likelihood of passing the routine travel route, to be preferentially matched with the user, rather than others of the supporter candidates, the others having a lower likelihood of passing the routine travel route.

7. The matching support system according to claim 1, further comprising:
a support continuation registration unit configured to perform support continuation registration for the user and the supporter candidate when receiving either support request continuation information transmitted from the user terminal or support provision continuation information transmitted from the supporter candidate terminal after the supporter candidate performs the predetermined support for the user, the support request continuation information indicating an intention to request the predetermined support for a next time to the supporter candidate, the support provision continuation information indicating an intention to provide the predetermined support for a next time to the user, wherein
the matching proposal unit transmits the matching proposal information to the supporter candidate terminal of the supporter candidate with the support continuation registration preferentially rather than the supporter candidate without the support continuation registration.

8. A matching support method that is executed by a computer so as to support matching between a user desiring predetermined support and a supporter capable of providing the predetermined support, comprising:
a support request accepting step of receiving support request information transmitted from a user terminal used by the user and accepting a request for the predetermined support from the user, the support request information including a desired implementation location, the desired implementation location being a location where the user desires to have the predetermined support implemented;
a support provision accepting step of receiving support provision information transmitted from a supporter terminal used by the supporter and accepting provision of the predetermined support by the supporter, the support provision information being for applying for provision of the predetermined support;
a routine travel route recognition step of recognizing a routine travel route, the routine travel route being a routine travel route of the supporter;
a supporter candidate extraction step of extracting the supporter as a supporter candidate to be matched with the user, the supporter having a distance from the routine travel route to the desired implementation location equal to or less than a predetermined distance; and
a matching proposing step of transmitting matching proposal information to a supporter candidate terminal, the matching proposal information being for proposing provision of the predetermined support for the user, the supporter candidate terminal being the supporter terminal used by the supporter candidate.
